(19) United States
(12) Patent Application Publication
(10) Pub. No.: US 2003/0127480 A1
(43) Pub. Date: Jul. 10, 2003

(54) In-car storage box

(75) Inventors: Mitsuo Hirota, Niigata-ken (JP); Kanya Ito, Niigata-ken (JP); Takahiro Saito, Niigata-ken (JP); Katsunari Utsugi, Niigata-ken (JP)

Correspondence Address: AKERMAN SENTERFITT, P.O. BOX 3188, WEST PALM BEACH, FL, 33402-3188, US

(73) Assignee: Twinbird Corporation, Niigata-ken (JP)

(21) Appl. No.: 10/321,322

(22) Filed: Dec. 17, 2002

(30) Foreign Application Priority Data
Jan. 7, 2002 (JP) 2002-000950

(51) Int. Cl. B60R 7/00

(52) U.S. Cl. 224/275

(57) ABSTRACT

An in-car storage box which can be reliably fastened on a seat in a vehicle. A container body 1 is formed with a belt groove 9 substantially orthogonal to the front-to-back direction of the container body 1. A seat belt B is hung on the belt groove 9 and tightened, so that the storage box can be firmly fastened onto the seat. Thus, it is possible to prevent the storage box from being moved within the vehicle even though a force of inertia is exerted thereupon by stepping on a brake or the like. Further, as at least one side of the belt groove is formed with a hook, the seat belt can stay in the belt groove without coming off there, thus ensuring the fastening of the seat belt. Still further, as the belt groove 9 is formed on an extension portion 7 which extends toward the inside of an opening 9, it is possible to make the storage box compact as a whole. Moreover, as the belt groove 9 is structured so as to be covered by a lid body 2, it is possible to more reliably prevent the seat belt B from coming off the belt groove 9.

### BACKGROUND OF THE INVENTION

1. Filed of the Invention

The present invention is related to an in-car storage box such as a cooler box, a refrigerator box or the like which is used on a car seat.

2. Prior Art

Conventionally, for this kind of storage boxes used on a car seat, a certain mechanism for fastening such storage box onto a seat has been needed as they are liable to drop off the seat in the worst case due to the shifting inside a car that is caused by an inertia force developed in stepping on a brake during the driving or taking a curve at an intersection or at a street corner. One of such conventional fastening mechanisms is disclosed in Japanese Examined Utility Model Publication No.2-1151, for example. The prior art proposes to provide an extension member including a block-shaped fastening body on a rear side of a storage box. The fastening body is inserted into between a backrest and a sitting seat to clamp the fastening body therebetween, thereby fastening the storage box on the seat.

However, as the fastening body is simply clamped between a backrest and a sitting seat according to the conventional in-car storage box, the fastening body is liable to come off between the backrest and the sitting seat if a large inertial force is applied thereto when stepping on a brake or taking a curve at an intersection or a street corner, thus leading to a risk that the storage box itself falls down or even tumbles within a car in the worst case. Such phenomenon is particularly noticeable because an inertial force applied to the storage box becomes large if it stores a large amount of food stuffs, or if it is integrated with a heavy component such as a built-in refrigerator. Particularly if such storage box is tumbled inside a car, it would be extremely dangerous.

### SUMMARY OF THE INVENTION

To eliminate the above-mentioned problems, it is, therefore, an object of the present invention to provide an in-car storage box which can be fastened reliably onto a seat inside a vehicle.

To attain the object, there is proposed an in-car storage box according to a first aspect of the invention, which includes: a container body having an opening; and a lid body provided at the opening of the container body, wherein the container body is formed with a belt groove for hanging a seat belt of a vehicle thereon.

With the structure thus made, the container body is fastened to the seat by passing the seat belt through the belt groove of the vehicle and then tightening the same.

Also, there is proposed in the present invention an in-car storage box according to the first aspect, in which at least one side of the belt groove is formed with a hook.

Accordingly, the seat belt can be prevented from coming off the belt groove by the hook.

Also, there is proposed in the present invention an in-car storage box according to the first or second aspect, in which the opening is formed with an extension portion which extends toward an inside of the opening, said extension portion including the belt groove formed thereon.

Thus, a space for forming the belt groove can be saved.

Still also, there is proposed in the present invention an in-car storage box according to any of the first to third aspects, in which said belt groove is provided in a position opposite to the lid body.

Accordingly, the seat belt can be prevented from coming off the belt groove by closing the lid body.

Still further, there is proposed in the present invention an in-car storage box according to any of the first to fourth aspects, in which the belt groove is provided in a rear part of an upper portion of the container body, referenced to a situation in which the in-car storage box is placed on a seat.

Accordingly, the container body can be fastened onto the seat by passing a short seat belt of a two-point support type equipped in the center seat of rear seats, through the belt groove.

Still also, there is proposed in the present invention an in-car storage box according to any of the foregoing first to fifth aspects, in which the belt groove is inclined so that it may be lowered toward a front, referenced to a situation in which the in-car storage box is placed on a seat.

With the structure thus made, the difference in angle between the seat belt and the belt groove can be reduced with respect to the widthwise direction.

### BRIEF DESCRIPTION OF THE DRAWINGS

For a more complete understanding of the present invention, reference is now made to the following description taken in conjunction with the accompanying drawings, in which:

FIG. 1 is a side view illustrating an in-car storage box according to a first embodiment of the present invention.

FIG. 2 is a section of the in-car storage box of the first embodiment.

FIG. 3 is an explanatory diagram illustrating steps from (a) to (d) for fastening the in-car storage box of the first embodiment to a seat inside a car.

FIG. 4 is a side view illustrating an in-car storage box according to a second embodiment of the present invention.

FIG. 5 is a section of the in-car storage box of the second embodiment.

FIG. 6 is a side view illustrating an in-car storage box according to a third embodiment of the present invention.

FIG. 7 is a section of the in-car storage box of the third embodiment.

FIG. 8 is a side view illustrating an in-car storage box according to a fourth embodiment of the present invention.

FIG. 9 is a section of the in-car storage box of the fourth embodiment.

FIG. 10 is a side view illustrating the in-car storage box according to the first embodiment, in which the in-car storage box is placed vertically, with its one side down.

### DETAILED DESCRIPTION OF THE PREFERRED EMBODIMETNS

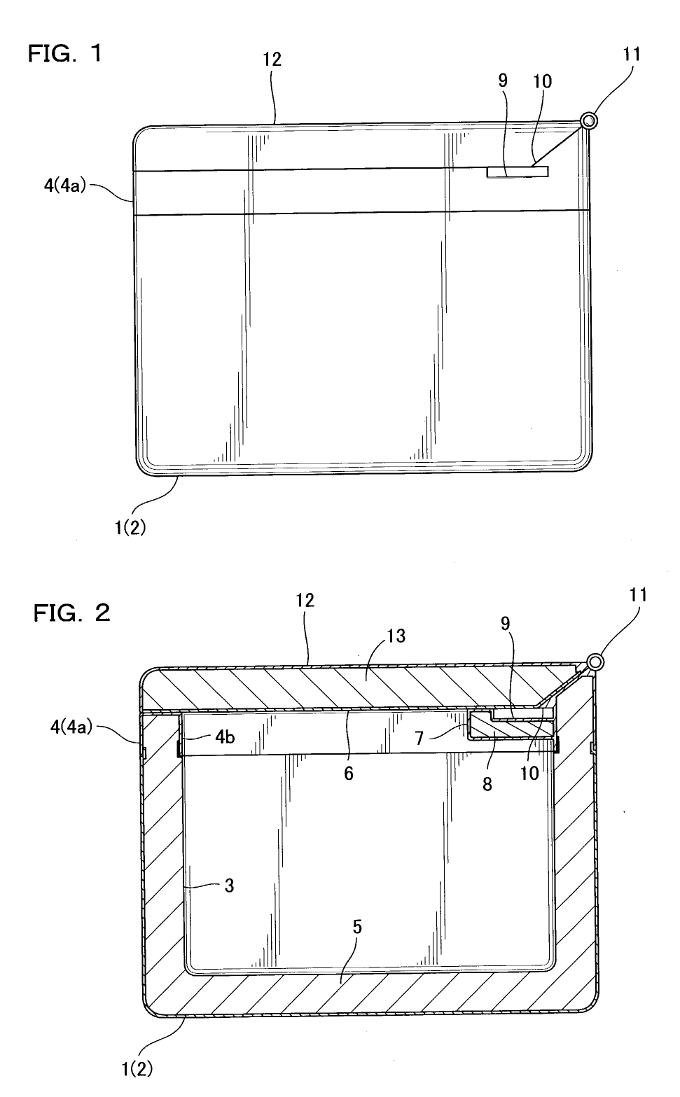

Hereinafter is described a first embodiment of the invention with reference to FIG. 1 to FIG. 3. In the following description, a cooler box is taken as an example of an in-car storage box of the invention, while in the respective drawings referred to hereinafter, a left side denotes a front side of the storage box, and a right side a rear side thereof, respectively.

Reference numeral 1 designates a container body which is made up of an outside container 2, an inside container 3, a top frame 4 and a heat-insulating material 5. The outside container 2 and the top frame 4 are made of synthetic resin, with the outside container 2 engaging an outside wall portion 4a of the top frame 4. On the other hand, the inside container 3 is made of metal such as aluminum or the like, and is fixed to an inside wall portion 4b of the top frame 4, using an adhesive tape (not shown) or the like. Further, an opening 6 is defined by an upper portion of the top frame 4. These outside container 2, inside container 3 and top frame 4 are engaged with one another, and then a heat insulating material 5 such as urethane foam is filled in a space defined between these components, so that the container body 1 is formed.

Also, the top frame 4 as one of the components of the container body 1 is formed with an extension portion 7 which extends toward the inside of the opening 6. Into the extension portion 7 is inserted a heat insulating member 8 such as polystyrene foam or the like. An upper surface of the extension portion 7 is formed with a belt groove 9 substantially orthogonal to the front-to-back direction of the container body 1, while a rear side of the belt groove 9 is integrally formed with a hook 10 protruding toward the front. The cooler box is formed compact as a whole by forming the belt groove 9 on the extension portion 7. Additionally, a lid body 12 is mounted in the vicinity of a rear end of the top frame 4, in a manner that is openable and closable via a hinge 11. Into the lid body 12 is inserted a heat insulating material 13 such as polystyrene foam.

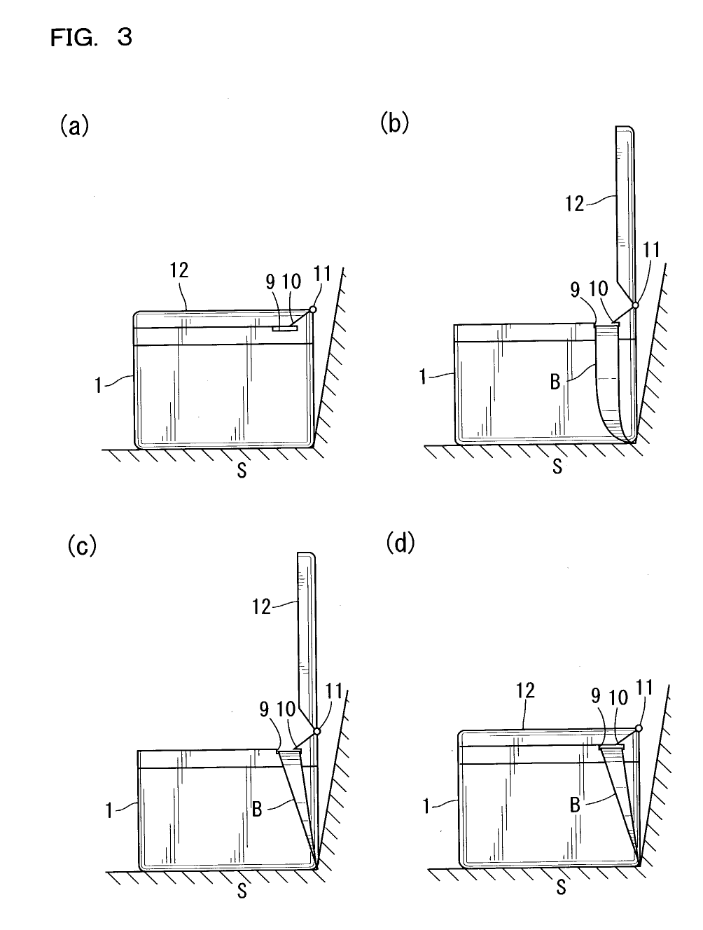

Next, the action of the in-car storage box of the present embodiment will be described with reference to FIG. 3.

Initially, the cooler box is placed on a seat S, as shown in FIG. 3(a). At this moment, a space inside a car can be effectively utilized without decreasing the number of occupants, if the cooler box is placed on a middle seat of a backseat. Then, the lid body 12 of the cooler box is opened so that a seat belt B is passed through the belt groove 9 exposed to the outside, as shown in FIG. 3(b). At this moment, a rear edge of the seat belt B is retained between the belt groove 9 and the hook 10, which is then tightened by adjusting the length of the seat belt B so as to fasten the cooler box to the seat S, as shown in FIG. 3(c). Thereafter, the lid body 12 is closed as shown in FIG. 3(d). At this moment, as the seat belt B is inclined widthwise so that the rear side thereof becomes higher relative to the horizontal plane, the seat belt B is urged to move rearwardly of the belt groove 9. However, it is allowed to stay there without coming off the belt groove 9 owing to the hook 10, thereby enabling the reliable fastening of the seat belt B with the seat belt B being passed through the belt groove 9. Further, as an upper portion of the belt groove 9 is covered by closing the lid body 12 from thereabove, the seat belt B is more reliably prevented from coming off the belt groove 9.

Under the above-mentioned condition, the cooler box is firmly fastened to the seat S by the seat belt B equipped in a vehicle, so that it is possible to prevent the cooler box from being moved within the vehicle even though a force of inertia is exerted upon the cooler box when stepping on a brake or taking a curve at an intersection or at a street corner. Specifically, if a forward force of inertia works on the cooler box when stepping on a brake, the cooler box is urged to fall forward, but it can well withstand such forward-urging force as the seat belt B is hung on the belt groove 9 in a relatively high position, according to the structure of the embodiment in which the fastening to the seat S is attained by hanging the seat belt B in the belt groove 9 formed in an upper portion of the container body 1 and then tightening the seat belt B. In the meantime, for detachment of the cooler box from the seat S, the lid body 12 may be opened and then the locking by a buckle (not shown) of the seat belt B may be released so as to remove the seat belt B from the belt groove 9. In the event of fastening the cooler box to the seat S again, the seat belt B may be simply passed through the belt groove 9 to allow buckles (not shown) to engage with each other, and then the lid body 12 may be closed, since the length of the seat belt B is already adjusted.

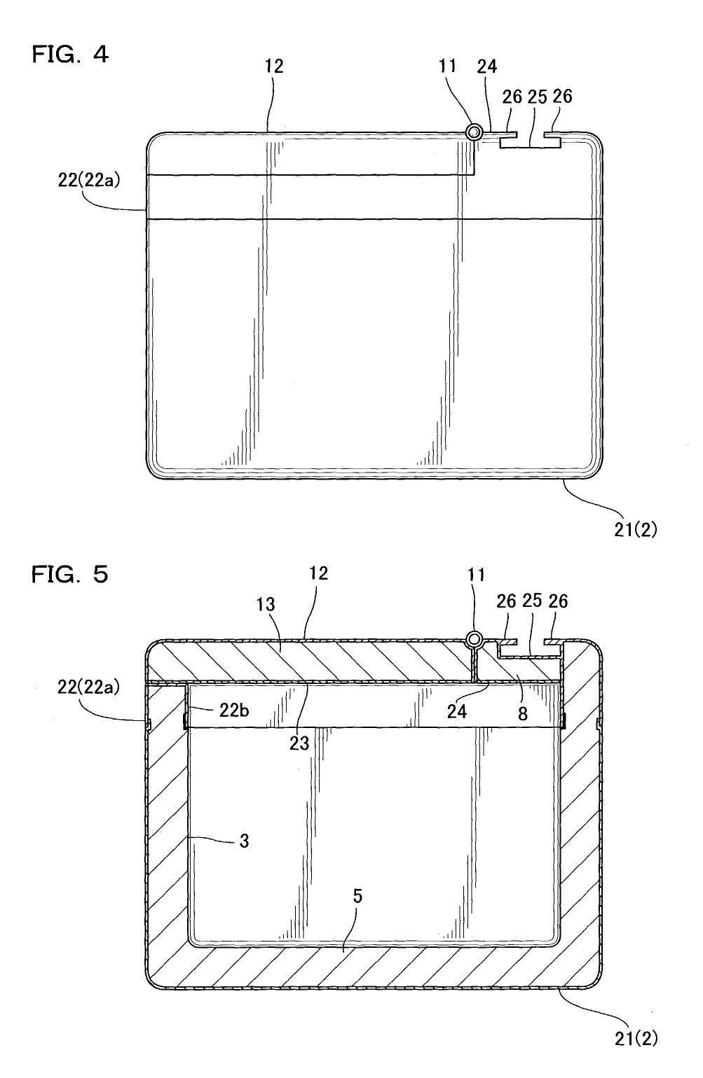

Next, a second embodiment of the invention will be described with reference to FIGS. 4 and 5, in which those described in the first embodiment will be designated by the same reference numerals, and their repeated detailed descriptions will be omitted.

Reference numeral 21 designates a container body, which is made up of the outside container 2, the inside container 3, a top frame 22 and the heat-insulating material 5. The outside container 2 and the top frame 22 are made of synthetic resin, with the outside container 2 engaging an outside wall portion 22a of the top frame 22. On the other hand, the inside container 3 is made of metal such as aluminum or the like, and is fixed to an inside wall portion 22b of the top frame 22, using an adhesive tape (not shown) or the like. Further, an opening 23 is defined by an upper portion of the top frame 22. These outside container 2, inside container 3 and top frame 22 are engaged with one another, and then a heat insulating material 5 such as urethane foam is filled in a space defined thereinside, so that the container body 21 is formed.

Also, the top frame 22 as one of the components of the container body 21 is formed with an extension portion 24 which extends toward the inside of the opening 23. Into the extension portion 24 is inserted the heat insulating member 8 such as polystyrene foam or the like. An upper surface of the extension portion 24 is formed with a belt groove 25 substantially orthogonal to the front-to-back direction of the container body 21, while both front and rear sides of the belt groove 25 are integrally formed with a hook 26 protruding therefrom. The cooler box is formed compact as a whole by forming the belt groove 25 on the extension portion 24. Additionally, the lid body 12 is mounted in the vicinity of a front end of the upper portion of the extension 24 in a manner that is openable and closable via the hinge 11. Into the lid body 12 is inserted the heat insulating material 13 such as polystyrene foam.

Next is a description of the action of the in-car storage box of the present embodiment.

Initially, the cooler box is placed on the seat S, and then the seat belt B is passed through the belt groove 25. At this moment, both edges of the seat belt B are retained between the belt groove 25 and the opposite hooks 26, which is then tightened by adjusting the length of the seat belt B so as to fasten the cooler box to the seat S. At this moment, as the seat belt B is inclined widthwise so that the rear side thereof becomes higher relative to the horizontal plane, the seat belt B is urged to move rearwardly of the belt groove 25 due to the tightening. However, it is allowed to stay there without coming off the belt groove 25 owing to the hooks 26, thereby enabling the reliable fastening of the seat belt B with the seat belt B being passed through the belt groove 25. The present embodiment is particularly advantageous in that as the front edge of the seat belt B also is retained by the hook 26, the seat belt B is more reliably prevented from coming off the belt groove 25.

Under this condition, the cooler box is firmly fastened to the seat S by the seat belt B equipped in a vehicle, so that it is possible to prevent the cooler box from being moved within the vehicle even though a force of inertia is exerted upon the cooler box when stepping on a brake or taking a curve at an intersection or at a street corner. Specifically, if a forward force of inertia works on the cooler box when stepping on a brake, the cooler box is urged to fall forward, but it can well withstand such fall-urging force as the seat belt B is hung on the belt groove 25 in a relatively high position, according to the structure of the embodiment in which the fastening to the seat S is attained by hanging the seat belt B in the belt groove 25 formed in an upper portion of the container body 21 and then tightening the seat belt B. In the meantime, for detachment of the cooler box from the seat S, the locking by a buckle (not shown) of the seat belt B may be released so as to remove the seat belt B from the belt groove 25. In the event of fastening the cooler box to the seat S again, the seat belt B may be simply passed through the belt groove 25 to allow buckles (not shown) to engage with each other, since the length of the seat belt B is already adjusted.

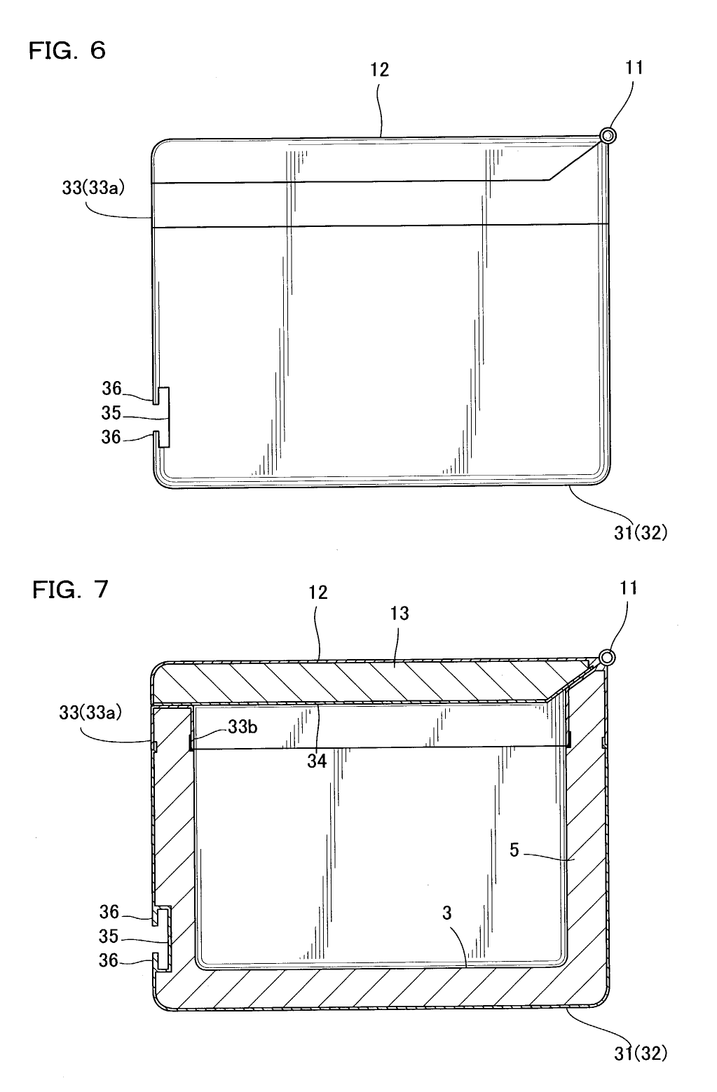

Next, a third embodiment of the invention will be described with reference to FIGS. 6 and 7.

Reference numeral 31 designates a container body, which is made up of an outside container 32, the inside container 3, a top frame 33 and the heat-insulating material 5. The outside container 32 and the top frame 33 are made of synthetic resin, with the outside container 32 engaging an outside wall portion 33a of the top frame 33. On the other hand, the inside container 3 is made of metal such as aluminum or the like, and is fixed to an inside wall portion 33b of the top frame 33, using an adhesive tape (not shown) or the like. Further, an opening 34 is defined by an upper portion of the top frame 33. These outside container 32, inside container 3 and top frame 33 are engaged with one another, and then the heat insulating material 5 such as urethane foam or the like is filled in a space defined thereinside, so that the container body 31 is formed.

Also, a front surface of the outside container 32 is formed with a belt groove 35 substantially orthogonal to the front-to-back direction of the container body 31, while both upper and lower sides of the belt groove 35 are integrally formed with a hook 36 protruding therefrom. Additionally, the lid body 12 is mounted in the vicinity of a rear end of the upper portion of the top frame 33 in a manner that is openable and closable via the hinge 11. Into the lid body 12 is inserted the heat insulating material 13 such as polystyrene foam.

Next is a description of the action of the in-car storage box of the present embodiment.

Initially, the cooler box is placed on the seat S, and then the seat belt B is passed through the belt groove 35. At this moment, both edges of the seat belt B are retained between the belt groove 35 and the opposite hooks 36, which is then tightened by adjusting the length of the seat belt B so as to fasten the cooler box to the seat S. At this moment, as the seat belt B is inclined widthwise so that the front side thereof becomes lower relative to the vertical plane, the seat belt B is urged to move downwardly of the belt groove 35 due to the tightening. However, it is allowed to stay there without coming off the belt groove 35 owing to the hooks 36, thereby enabling the reliable fastening of the seat belt B with the seat belt B being passed through the belt groove 35. The present embodiment is particularly advantageous in that as the upper edge of the seat belt B also is retained by the hook 36, the seat belt B is more reliably prevented from coming off the belt groove 35.

Under this condition, the cooler box is firmly fastened to the seat S by the seat belt B equipped in a vehicle, so that it is possible to prevent the cooler box from being moved within the vehicle even though a force of inertia is exerted upon the cooler box when stepping on a brake or taking a curve at an intersection or at a street corner. In the meantime, for detachment of the cooler box from the seat S, the locking by a buckle (not shown) of the seat belt B may be released so as to remove the seat belt B from the belt groove 35. In the event of fastening the cooler box to the seat S again, the seat belt B may be simply passed through the belt groove 35 to allow buckles (not shown) to engage with each other, since the length of the seat belt B is already adjusted.

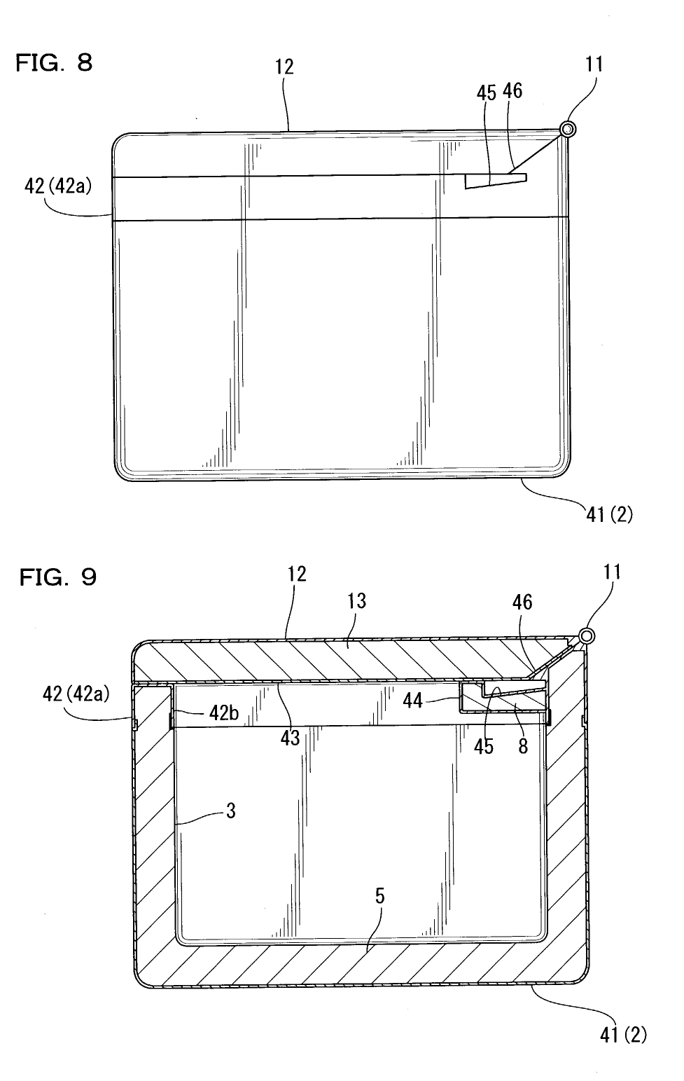

Next, a fourth embodiment of the invention will be described with reference to FIGS. 8 and 9.

Reference numeral 41 designates a container body, which is made up of the outside container 2, the inside container 3, a top frame 42 and the heat-insulating material 5. The outside container 2 and the top frame 42 are made of synthetic resin, with the outside container 2 engaging an outside wall portion 42a of the top frame 42. On the other hand, the inside container 3 is made of metal such as aluminum or the like, and is fixed to an inside wall portion 42b of the top frame 42, using an adhesive tape (not shown) or the like. Further, an opening 43 is defined by an upper portion of the top frame 42. These outside container 2, inside container 3 and top frame 42 are engaged with one another, and then the heat insulating material 5 such as urethane foam or the like is filled in a space defined thereinside, so that the container body 41 is formed.

Also, the top frame 42 as one of the components of the container body 41 is formed with an extension portion 44 which extends toward the inside of the opening 43. Into the extension portion 44 is inserted the heat insulating member 8 such as polystyrene foam or the like. An upper surface of the extension portion 44 is formed with a belt groove 45 substantially orthogonal to the front-to-back direction of the container body 41, while a rear side of the belt groove 45 is integrally formed with a hook 46 protruding toward the front. Specifically, the belt groove 45 is formed so as to have a slightly lower front edge. The cooler box is formed compact as a whole by forming the belt groove 45 on the extension portion 44. Additionally, the lid body 12 is mounted in the vicinity of a rear end of the upper portion of the top frame 42 in a manner that is openable and closable via the hinge 11. Into the lid body 12 is inserted the heat insulating material 13 such as polystyrene foam.

Next is a description of the action of the in-car storage box of the present embodiment.

Initially, the cooler box is placed on the seat S, and then the lid body 12 of the cooler box is opened so that the seat belt B is passed through the belt groove 45 exposed to the outside. At this moment, the rear edge of the seat belt B is retained between the belt groove 45 and the hook 46, which is then tightened by adjusting the length of the seat belt B so as to fasten the cooler box to the seat S, and then the lid body 12 is closed. At this moment, the seat belt B is inclined widthwise so that the rear side thereof becomes higher relative to the horizontal plane, or in other words, it is inclined so that the front side thereof becomes lowered. Nevertheless, it is allowed to stay there without coming off the belt groove 45 owing to the hook 46, thereby enabling the reliable fastening of the seat belt B with the seat belt B being passed through the belt groove 45. The present embodiment is particularly advantageous in that as the belt groove 45 is inclined so as to become lower toward the front, the difference in angle between the seat belt B and the belt groove 45 (i.e., the angle of the seat belt B to the belt groove 45) becomes smaller, the seat belt B can be more reliably fastened. Moreover, as an upper portion of the belt groove 45 is covered by closing the lid body 12 from thereabove, the seat belt B is further more reliably prevented from coming off the belt groove 45.

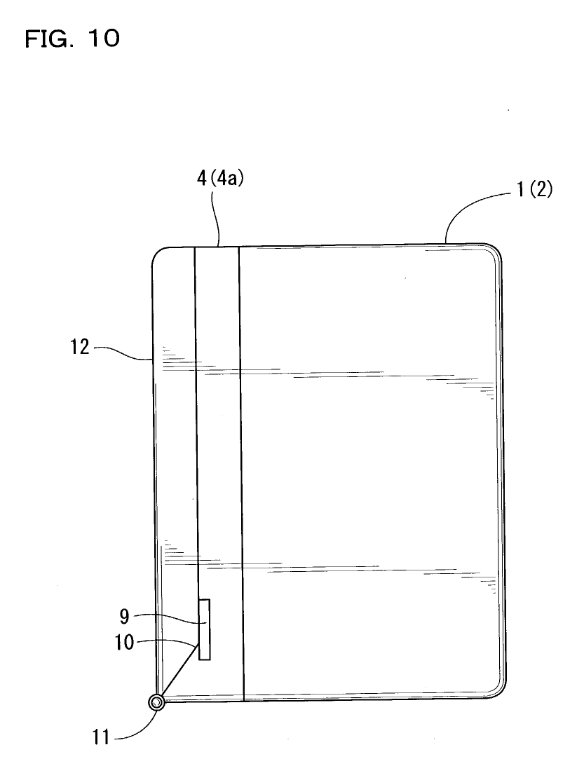

Under this condition, the cooler box is firmly fastened to the seat S by the seat belt B equipped in a vehicle, so that it is possible to prevent the cooler box from being moved within the vehicle even though a force of inertia is exerted upon the cooler box when stepping on a brake or taking a curve at an intersection or at a street corner. Specifically, if a forward force of inertia works on the cooler box when stepping on a brake, the cooler box is urged to fall forward, but it can well withstand such forward-urging force as the seat belt B is hung on the belt groove 45 in a relatively high position, according to the structure of the embodiment in which the fastening to the seat S is attained by hanging the seat belt B in the belt groove 45 formed in an upper portion of the container body 41 and then tightening the seat belt B. In the meantime, for detachment of the cooler box from the seat S, the lid body 12 may be opened and then the locking by a buckle (not shown) of the seat belt B may be released so as to remove the seat belt B from the belt groove 45. In the event of fastening the cooler box to the seat S again, the seat belt B may be simply passed through the belt groove 45 to allow buckles (not shown) to engage with each other, and then the lid body 12 may be closed, since the length of the seat belt B is already adjusted. Although the cooler box is placed horizontally in the foregoing embodiments, it may be placed vertically, with its one side down, as illustrated in FIG. 10. In that case as well, it can be retained and used in the same manner.

According to the present invention, the belt groove is formed substantially orthogonal to the front-to-back direction of the container body so that the seat belt may be hung on the belt groove and tightened, whereby the storage box can be firmly fastened to the seat, thus making it possible to prevent the storage box from being moved within the vehicle even though a force of inertia is exerted thereupon by stepping on a brake or the like. Further, as at least one side of the belt groove is formed with a hook, the seat belt can stay in the belt groove without coming off therefrom, thus ensuring the fastening of the seat belt. Still further, as the belt groove is formed on the extension portion which extends toward the inside of the opening, it is possible to make the storage box compact as a whole. Moreover, as the belt groove is structured so as to be covered by the lid body, it is possible to more reliably prevent the seat belt from coming off the belt groove. Additionally, as the belt groove is formed in the upper portion of the container body, not only can the storage box of the invention be used for a short seat belt of a two-point support type provided on a center seat of rear seats, but also can it well withstand the fall-urging force developed when the storage box is urged to fall forward. Also, as the belt groove is formed so as to become lower toward the front end, the difference in angle between the seat belt and the belt groove is reduced, thereby enabling the further reliable fastening of the seat belt.

Incidentally, the present invention should not be limited to the foregoing embodiments, but may be modified within a scope of the invention. For example, whilst the cooler box is taken as an example of the storage box of the invention in the foregoing embodiments, it may be a refrigerator or the like. Alternatively, it may be a container of a non-heat-insulating type. Also, the belt groove has only to be provided either at a front or at an upper side of the container body.

What is claimed:

1. An in-car storage box comprising:
a container body having an opening; and
a lid body provided at the opening of the container body,
wherein said container body is formed with a belt groove for hanging a seat belt of a vehicle thereon.

2. An in-car storage box according to claim 1,
wherein at least one side of said belt groove is formed with a hook.

3. An in-car storage box according to claim 1,
wherein said opening is formed with an extension portion which extends toward an inside of the opening, said extension portion including said belt groove formed thereon.

4. An in-car storage box according to claim 1,
wherein said belt groove is provided in a position opposite to said lid body.

5. An in-car storage box according to claim 1,
wherein said belt groove is provided in a rear part of an upper portion of said container body, referenced to a situation in which the in-car storage box is placed on a seat.

6. An in-car storage box according to claim 1,
wherein said belt groove is inclined so that it may be lowered toward a front, referenced to a situation in which the in-car storage box is placed on a seat.

7. An in-car storage box according to claim 2,
wherein said opening is formed with an extension portion which extends toward an inside of the opening, said extension portion including said belt groove formed thereon.

8. An in-car storage box according to claim 2,
wherein said belt groove is provided in a position opposite to said lid body.

9. An in-car storage box according to claim 3,
wherein said belt groove is provided in a position opposite to said lid body.

10. An in-car storage box according to claim 2,
wherein said belt groove is provided in a rear part of an upper portion of said container body, referenced to a situation in which the in-car storage box is placed on a seat.

11. An in-car storage box according to claim 3,
wherein said belt groove is provided in a rear part of an upper portion of said container body, referenced to a situation in which the in-car storage box is placed on a seat.

12. An in-car storage box according to claim 4,
wherein said belt groove is provided in a rear part of an upper portion of said container body, referenced to a situation in which the in-car storage box is placed on a seat.

13. An in-car storage box according to claim 2,
wherein said belt groove is inclined so that it may be lowered toward a front, referenced to a situation in which the in-car storage box is placed on a seat.

14. An in-car storage box according to claim 3,
wherein said belt groove is inclined so that it may be lowered toward a front, referenced to a situation in which the in-car storage box is placed on a seat.

15. An in-car storage box according to claim 4,
wherein said belt groove is inclined so that it may be lowered toward a front, referenced to a situation in which the in-car storage box is placed on a seat.

16. An in-car storage box according to claim 5,
wherein said belt groove is inclined so that it may be lowered toward a front, referenced to a situation in which the in-car storage box is placed on a seat.
